(19) United States
(12) Patent Application Publication
(10) Pub. No.: US 2023/0045514 A1
(43) Pub. Date: Feb. 9, 2023

(54) APPARATUS, SYSTEM, AND METHOD FOR ACHIEVING IMPROVED GROUND STATION DESIGN

(71) Applicant: Meta Platforms, Inc., Menlo Park, CA (US)

(72) Inventors: Farbod Tabatabai, San Francisco, CA (US); Eric Udell, Cypress, TX (US)

(21) Appl. No.: 17/705,909

(22) Filed: Mar. 28, 2022

Related U.S. Application Data
(60) Provisional application No. 63/231,108, filed on Aug. 9, 2021.

(51) Int. Cl. H01Q 1/50; H01R 24/40; H01P 3/08

(52) U.S. Cl. CPC H01Q 1/50; H01R 24/40; H01P 3/08; H01R 2103/00

(57) ABSTRACT

A radio-frequency device comprising (1) a ceramic component that forms a hole and (2) a connector coupled to the ceramic component, wherein the connector comprises an electrically conductive pin that at least partially extends into the hole formed in the ceramic component. Various other apparatuses, systems, and methods are also disclosed.

### INCORPORATION BY REFERENCE

This application claims the benefit of priority under 35 U.S.C. § 119(e) to U.S. Provisional Application No. 63/231,108 filed Aug. 9, 2021, the contents of which are incorporated herein by reference in their entirety.

### BRIEF DESCRIPTION OF DRAWINGS

The accompanying drawings illustrate a number of exemplary embodiments and are parts of the specification. Together with the following description, the drawings demonstrate and explain various principles of the instant disclosure.

FIG. 1 is an illustration of an exemplary radio-frequency (RF) device that facilitates improved ground station design according to one or more embodiments of this disclosure.

FIG. 2 is an illustration of an exemplary RF device that facilitates improved ground station design according to one or more embodiments of this disclosure.

FIG. 3 is an illustration of an exemplary RF device that facilitates improved ground station design according to one or more embodiments of this disclosure.

FIG. 4 is an illustration of an exemplary system including a satellite and a remote radio unit of a ground station according to one or more embodiments of this disclosure.

FIG. 5 is an illustration of an exemplary RF device that facilitates improved ground station design according to one or more embodiments of this disclosure.

FIG. 6 is an illustration of an exemplary RF device that facilitates improved ground station design according to one or more embodiments of this disclosure.

FIG. 7 is a flowchart of an exemplary method for achieving improved ground station design according to one or more embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION

The present disclosure is generally directed to apparatuses, systems, and methods for achieving improved ground station design. As will be explained in greater detail below, these apparatuses, systems, and methods may provide numerous features and benefits.

Ground station design typically aims for lower size, weight, power consumption, and/or cost. Sometimes these features are partially or collectively referred to as SWaP (size, weight, and power). Certain components (such as filters and/or waveguides) may dictate, control, and/or influence whether ground stations are able to achieve those aims. Some of those components may constitute and/or represent part of a remote radio unit in a ground station. Conventional examples of such components may include and/or form air-filled cavities fabricated from metals (e.g., aluminum). Unfortunately, those conventional components that include air-filled metal cavities may be physically large enough to result in a high insertion loss, thereby potentially increasing the power consumption of a corresponding power amplifier. Moreover, those conventional components that include air-filled cavities in a metal housings may also be bulky and/or relatively high cost.

The instant disclosure, therefore, identifies and addresses a need for additional apparatuses, systems, and methods for achieving improved ground station design. In some instances, the weight, bulk, and/or cost of RF components may be reduced using solid dielectric components rather than air-filled metal cavities. Dielectric components (such as ceramic resonators and/or ceramic waveguides) may facilitate and/or provide significant reductions in the volume and/or weight of RF devices. RF devices may include and/or represent components of an RF circuit (such as a cellular ground station).

In some examples, the use of ceramic in place of air-filled metal cavities may help reduce the size of the components included in RF devices. As a result, the overall size of such RF devices and/or corresponding systems may also decrease. The size reduction and/or decrease may be by factor of √(εᵣ), where εᵣ represents the relative dielectric constant of the dielectric material (such as a ceramic) at an operational frequency. In addition, certain ceramic components may facilitate and/or provide improved electrical and/or RF connections compared with those achieved via air-filled cavities in metal housings.

In some examples, RF devices may achieve improved electrical and/or RF connections between RF connectors (such as coaxial connectors) and ceramic-based components (such as waveguides, filters, etc.). Some RF devices may be configured and/or designed for operation at radio frequencies, including communication network frequencies like those implemented in 3G bands, 4G bands, long-term evolution (LTE) bands, wireless broadband communication protocol bands, and/or 5G bands.

In some examples, such RF devices may include and/or represent ceramic-based components like waveguides, resonators, and/or filters (e.g., bandpass filters and/or multiple bandpass filters with different band center frequencies). The SWaP and cost of an RF device that includes ceramic components may be greatly improved compared to an RF device that includes components with air-filled metal cavities.

In some examples, electrical and/or RF connections may be formed and/or implemented between RF components like an RF connector and an RF ceramic waveguide. Alternative electrical and/or RF connections may be formed and/or implemented between an RF connector and a ceramic filter or resonator. Additional electrical and/or RF connections may be formed and/or implemented between two ceramic waveguides or between a ceramic waveguide and a ceramic resonator. In one example, an RF connector may include and/or represent a waveguide, a coaxial connector, and/or another signal conveyance mechanism.

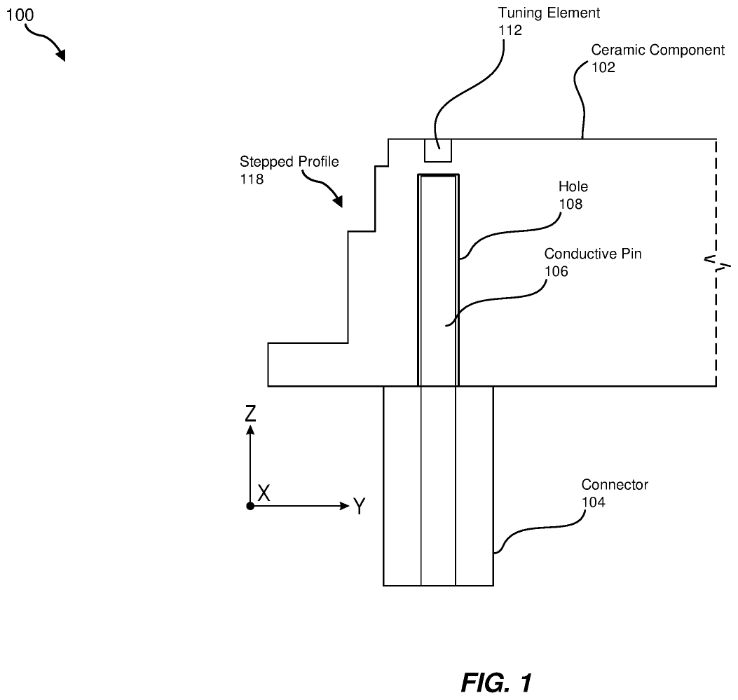

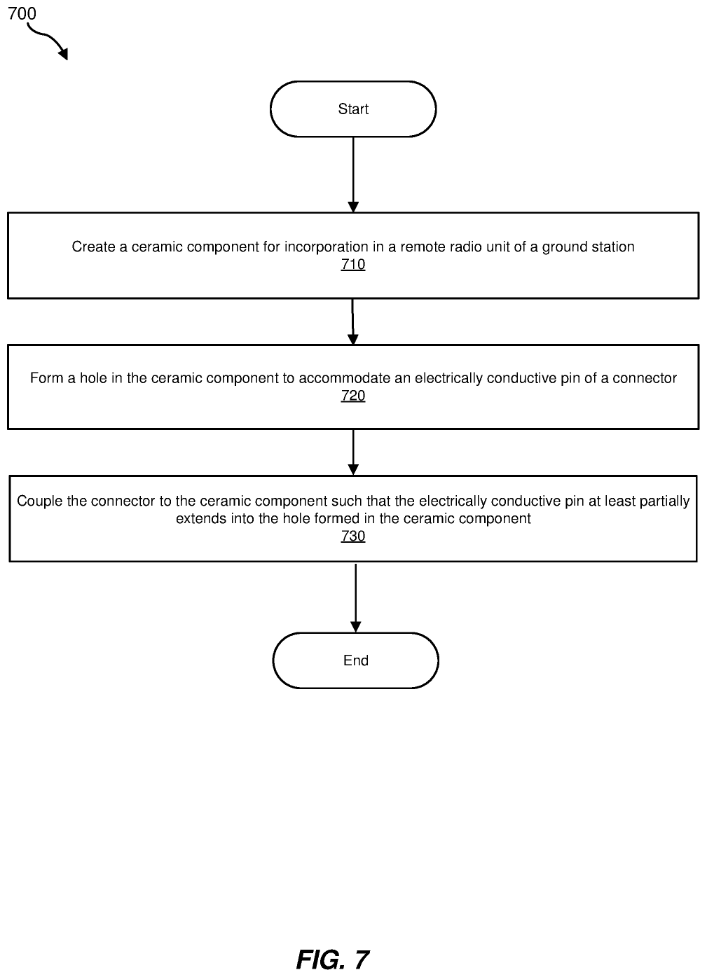

The following will provide, with reference to FIGS. 1-6, detailed descriptions of exemplary apparatuses, systems, components, and structures for achieving improved ground station design. In addition, detailed descriptions of exemplary methods for achieving improved ground station design will be provided in connection with FIG. 7.

FIG. 1 illustrates an exemplary RF device 100 that includes and/or represents a ceramic component 102 and a connector 104. As illustrated in FIG. 1, ceramic component 102 may include and/or form a hole 108. In some examples, connector 104 may be physically, electrically, and/or communicatively coupled to ceramic component 102. In such examples, connector 104 may include, incorporate, and/or contain an electrically conductive pin 106. In one example, conductive pin 106 may at least partially extend and/or jut into hole 108 formed in ceramic component 102.

In some examples, the coupling between ceramic component 102 and connector 104 may constitute and/or represent an electrical and/or RF connection or structure. In such examples, hole 108 may be configured and/or designed to receive conductive pin 106 (e.g., with the diameter of at least that of the pin). In one example, conductive pin 106 may include and/or represent an electrically conductive extension of the central conductor included and/or incorporated into connector 104. Additionally or alternatively, conductive pin 106 may constitute and/or represent a portion and/or part of the central conductor from which surrounding material has been removed and/or discarded.

In some examples, conductive pin 106 may include and/or represent an elongated electrical conductor, such as an elongated metal element. The cross-section of conductive pin 106 may be any of a variety of shapes and/or dimensions. For example, the cross-section of conductive pin 106 may be circular and/or cylindrical. Additional examples of shapes formed by conductive pin 106 include, without limitation, ovoids, rectangular, cubes, cuboids, spheres, spheroids, cones, prisms, variations or combinations of one or more of the same, and/or any other suitable shapes.

Conductive pin 106 may be sized in a particular way to fit within connector 104 and/or hole 108 of ceramic component 102. Conductive pin 106 may include and/or contain any of a variety of materials. Examples of such materials include, without limitation, metals, coppers, aluminums, steels, stainless steels, silver, gold, platinum, palladium, variations or combinations of one or more of the same, and/or any other suitable materials.

The cross-section of connector 104 may be any of a variety of shapes and/or dimensions. For example, the cross-section of connector 104 may be circular and/or cylindrical. Additional examples of shapes formed by connector 104 include, without limitation, ovoids, rectangular, cubes, cuboids, spheres, spheroids, cones, prisms, variations or combinations of one or more of the same, and/or any other suitable shapes.

Connector 104 may be sized in a particular way to interface with and/or couple to ceramic component 102. Connector 104 may include and/or contain any of a variety of materials. Examples of such materials include, without limitation, metals, coppers, aluminums, steels, stainless steels, silver, gold, platinum, palladium, plastics, ceramics, polymers, composites, rubbers, variations or combinations of one or more of the same, and/or any other suitable materials.

In one example, connector 104 may include and/or represent dielectric material and/or an electrical insulator layer that surrounds a central electrical conductor. Examples of such dielectric materials include, without limitation, ceramics, porcelains, glasses, plastics, industrial coatings, silicon, germanium, gallium arsenide, mica, metal oxides, silicon dioxides, sapphires, aluminum oxides, polymers, glass-ceramics, composites, variations or combinations of one or more of the same, and/or any other suitable dielectric materials.

The cross-section of ceramic component 102 may be any of a variety of shapes and/or dimensions. For example, ceramic component 102 may be rectangular and/or box-shaped. Additional examples of shapes formed by ceramic component 102 include, without limitation, ovoids, cubes, cuboids, spheres, spheroids, cones, prisms, cylinders, variations or combinations of one or more of the same, and/or any other suitable shapes.

Ceramic component 102 may be sized in a particular way to interface with and/or couple to connector 104. Ceramic component 102 may include and/or contain any of a variety of materials. Examples of such materials include, without limitation, inorganic nonmetallic materials, clays, silicas, silicons, porcelains, mullites, stonewares, earthenwares, oxide materials, nitride materials, carbon materials, carbide materials, kaolinites, tungsten carbides, silicon carbides, variations or combinations of one or more of the same, and/or any other suitable materials.

In some examples, the distal end of the conductive pin 106 (relative to connector 104) may be flat or rounded. In such examples, the proximate end of conductive pin 106 (relative to connector 104) may be soldered or otherwise mechanically and/or electrically attached to a central conductor of connector 104. In one example, the proximate end of conductive pin 106 may be an exposed terminal side of the central conductor.

In some examples, exemplary RF device 100 may include and/or represent a tuning element 112 that facilitates adjusting and/or modifying the frequency parameters of RF device 100 and/or a corresponding RF signal. Examples of such frequency parameters may include, without limitation, transmission bandwidth, transmission band center frequency, variations or combinations of one or more of the same, and/or any other suitable frequency parameters. In one example, tuning element 112 may be inserted into a hole located and/or positioned on the side opposite connector 104.

The cross-section of tuning element 112 may be any of a variety of shapes and/or dimensions. For example, the cross-section of tuning element 112 may be circular and/or cylindrical. Additional examples of shapes formed by tuning element 112 include, without limitation, ovoids, rectangular, cubes, cuboids, spheres, spheroids, cones, prisms, variations or combinations of one or more of the same, and/or any other suitable shapes.

Tuning element 112 may be sized in a particular way to fit within a hole of ceramic component 102. Tuning element 112 may include and/or contain any of a variety of materials. Examples of such materials include, without limitation, metals, coppers, aluminums, steels, stainless steels, silver, gold, platinum, palladium, variations or combinations of one or more of the same, and/or any other suitable materials.

In some examples, hole 108 may be located and/or positioned approximately one quarter wavelength of the transmission bandwidth of RF device 100 from an end and/or outer surface of ceramic component 102. In one example, the end and/or outer surface of ceramic component 102 may include and/or represent a stepped profile 118 configured and/or intended to obtain a desired bandwidth for the connection. In this example, hole 108 may be located and/or positioned approximately one quarter wavelength of the transmission band from the left-most portion of stepped profile 118 as illustrated in FIG. 1. Accordingly, hole 108 may be located and/or positioned less than one quarter wavelength of the transmission band from the right-most portion of stepped profile 118 as illustrated in FIG. 1.

In some examples, stepped profile 118 may include and/or represent three steps and/or levels that correspond to various displacements of the end surface along the y-direction moving up the end surface along the z-axis (according to the illustrated axes). In one example, the steps may be larger towards the side of ceramic component 102 into which conductive pin 106 is inserted. In this example, stepped profile 118 may be configured and/or intended to provide greater than a 5% bandwidth. This percentage may be based at least in part on the ratio of the bandwidth to the pass band center frequency.

In some examples, the connection formed between ceramic component 102 and connector 104 may constitute and/or represent an input connection and/or an output connection of RF device 100. In one example, ceramic component 102 may include and/or represent a waveguide. In this example, ceramic component 102 may be configured and/or designed to carry and/or transmit an RF signal to connector 104. Additionally or alternatively, connector 104 may be configured and/or designed to carry and/or transmit an RF signal to ceramic component 102.

RF device 100 may be manufactured and/or assembled in a variety of ways. In some examples, hole 108 may be formed and/or incorporated in ceramic component 102. In such examples, upon formation of hole 108, conductive pin 106 may be inserted and/or set into hole 108. In one example, conductive pin 106 may be exposed and/or unmasked by removing one or more encircling materials (e.g., including a dielectric material) from around an end portion of the central conductor of connector 104. In this example, conductive pin 106 may extend from and/or be in electrical communication with the central conductor of connector 104.

In some examples, connector 104 may include and/or represent a coaxial fitting and/or connector with a central conductor, and ceramic component 102 may include and/or represent a waveguide. In one example, conductive pin 106 may be electrically connected to and/or may physically extend from the central conductor of the coaxial connector. An RF signal may traverse and/or travel from the coaxial fitting and/or connector to the waveguide. Additionally or alternatively, the RF signal may traverse and/or travel from the waveguide to the coaxial fitting and/or connector.

In some examples, connector 104 may provide an electrical and/or RF connection to a socket or similar structure on ceramic component 102 and/or opposite ceramic component 102. In one example, connector 104 may be received by the socket, and the socket may facilitate and/or provide an electrical or RF coupling between ceramic component 102 and connector 104. In this example, the socket may be electrically connected to conductive pin 106, and/or conductive pin 106 may be extended to electrically connect to the socket.

In some examples, ceramic component 102 may include and/or represent a solid ceramic body, and hole 108 may be formed in the solid ceramic body. In one example, the solid ceramic body may be formed into and/or take the shape of a rectangular prism and/or a cuboid. Additionally or alternatively, ceramic component 102 may include and/or represent a semi-hollow ceramic body and/or a hollow ceramic body. Accordingly, in certain embodiments, ceramic component 102 may include and/or form one or more cavities.

In some examples, ceramic component 102 may include and/or represent a waveguide, a resonator, and/or a bandpass filter. Additionally or alternatively, RF device 100 may include and/or represent a waveguide, a resonator, and/or a bandpass filter. In one example, connector 104 may include and/or represent an input connector with a central conductor. In this example, conductive pin 106 may be electrically connected to and/or may physically extend from the central conductor of the input connector.

In some examples, connector 104 may include and/or represent an output connector with a central conductor. In such examples, conductive pin 106 may be electrically connected to and/or may physically extend from the central conductor of the output connector. In one example, the output connector may include and/or represent a coaxial fitting.

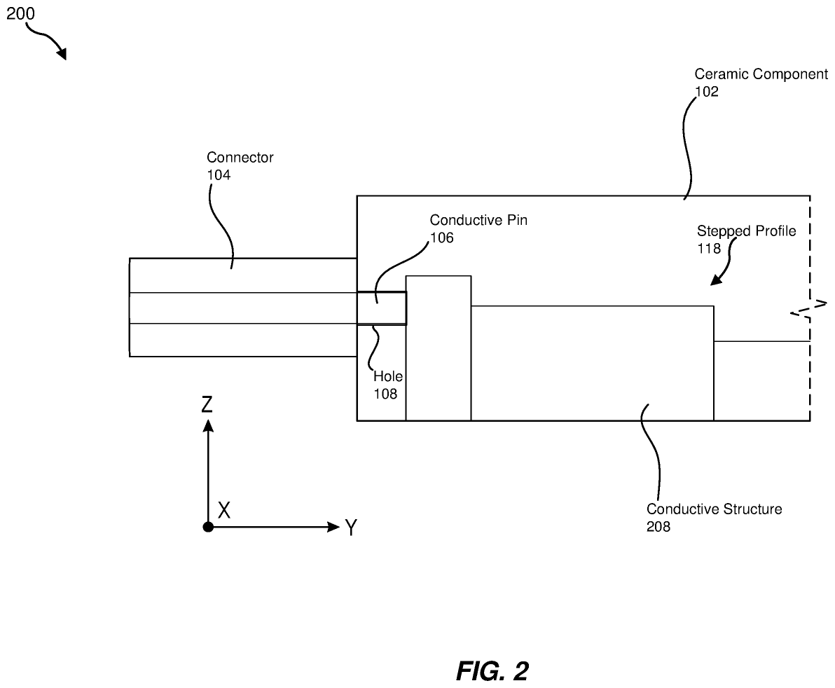

FIG. 2 illustrates an exemplary RF device 200 that includes and/or represents ceramic component 102 and connector 104. As illustrated in FIG. 2, ceramic component 102 may include and/or form hole 108. In some examples, connector 104 may be physically, electrically, and/or communicatively coupled to ceramic component 102. In such examples, connector 104 may include, incorporate, and/or contain conductive pin 106. In one example, conductive pin 106 may at least partially extend and/or jut into hole 108 formed in ceramic component 102.

In some examples, hole 108 may include and/or form a diameter of at least that of conductive pin 106. In one example, conductive pin 106 may include and/or represent an extension of the central conductor of connector 104. In this example, conductive pin 106 may be exposed and/or provided by a portion of the central conductor from which surrounding materials have been removed.

In some examples, RF device 200 may also include and/or represent an electrically conductive structure 208 to which conductive pin 106 is electrically coupled and/or connected. In these examples, conductive pin 106 may interface with and/or feed ceramic component 102 horizontally such that the elongated direction of conductive pin 106 runs parallel to the elongated direction of ceramic component 102. In one example, conductive structure 208 may include and/or represent a machined metal that is at least partially surrounded and/or enveloped by ceramic component 102. In another example, conductive structure 208 may include and/or represent a machined metal placed and/or positioned adjacent to ceramic component 102.

In some examples, conductive structure 208 may include, have, and/or form stepped profile 118. In one example, stepped profile 118 may be formed and/or created on or by a surface of conductive structure that is covered ceramic material.

In some examples, stepped profile 118 of conductive structure 208 may facilitate and/or support obtaining and/or reaching a wider bandwidth. In one example, the length of conductive structure 208 may be approximately one half wavelength of the transmission bandwidth of RF device 100. In this example, conductive pin 106 may extend from the central conductor of connector 104. In one example, conductive pin 106 may be soldered and/or electrically coupled to conductive structure 208. Additionally or alternatively, a metallic insert and/or coupling may be placed and/or positioned between conductive pin 106 and conductive structure 208 within ceramic component 102.

Conductive structure 208 may be any of a variety of shapes and/or dimensions. For example, the cross-section of conductive structure 208 may be circular and/or cylindrical. Additional examples of shapes formed by conductive structure 208 include, without limitation, ovoids, rectangular, cubes, cuboids, spheres, spheroids, cones, prisms, variations or combinations of one or more of the same, and/or any other suitable shapes.

Conductive structure 208 may be sized in a particular way to fit within hole 108 of ceramic component 102. Conductive structure 208 may include and/or contain any of a variety of materials. Examples of such materials include, without limitation, metals, coppers, aluminums, steels, stainless steels, silver, gold, platinum, palladium, variations or combinations of one or more of the same, and/or any other suitable materials.

RF device 200 may be manufactured and/or assembled in a variety of ways. In some examples, hole 108 may be formed and/or incorporated in a central region of an end and/or outer surface of ceramic component 102. In such examples, upon formation of hole 108, conductive pin 106 may be inserted and/or set into hole 108. In one example, conductive pin 106 may be exposed and/or unmasked by removing one or more encircling materials (e.g., including a dielectric material) from around an end portion of the central conductor of connector 104. In this example, conductive pin 106 may extend from and/or be electrically coupled to the central conductor of connector 104. Conductive pin 106 may also be electrically coupled and/or connected to conductive structure 208 via hole 108 of ceramic component 102.

In some examples, connector 104 may include and/or represent a coaxial fitting and/or connector with a central conductor, and ceramic component 102 may include and/or represent a waveguide. In one example, conductive pin 106 may be electrically connected between and/or may physically extend between the central conductor of the coaxial connector and conductive structure 208. An RF signal may traverse and/or travel from the coaxial fitting and/or connector to the waveguide via conductive pin 106 and/or conductive structure 208. Additionally or alternatively, the RF signal may traverse and/or travel from the waveguide to the coaxial fitting and/or connector via conductive pin 106 and/or conductive structure 208.

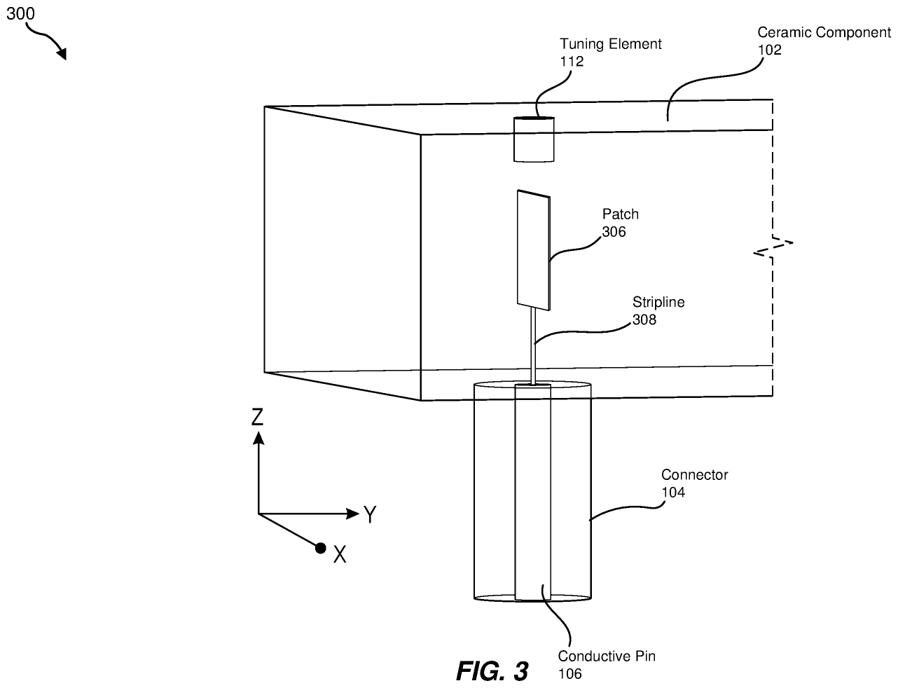

FIG. 3 illustrates an exemplary RF device 300 that includes and/or represents ceramic component 102 and connector 104. As illustrated in FIG. 3, ceramic component 102 may include and/or form a hole fitted to accommodate a patch 306 and/or a stripline 308. In some examples, connector 104 may be physically, electrically, and/or communicatively coupled to ceramic component 102. In such examples, connector 104 may include, incorporate, and/or contain conductive pin 106. In one example, conductive pin 106 may be physically and/or electrically coupled to stripline 308. In this example, stripline 308 may be physically and/or electrically coupled between conductive pin 106 and patch 306.

In some examples, connector 104 may include and/or represent a surface mount attached to a stripline connection printed onto ceramic component 102. In such examples, stripline 308 may be electrically connected to patch 306. Stripline 308 and/or patch 306 may include and/or represent one or more electrically conductive materials. Examples of such materials include, without limitation, metals, coppers, aluminums, steels, stainless steels, silver, gold, platinum, palladium, variations or combinations of one or more of the same, and/or any other suitable materials. In one example, patch 306 may facilitate and/or support coupling an RF signal from connector 104 into ceramic component 102. For example, stripline 308 and/or patch 306 may be formed on one end of ceramic component 102 (such as a ceramic waveguide).

In some examples, ceramic component 102 may include, have, and/or form a dimension (e.g., length along the y-axis) equal to approximately one half wavelength on one or more sides of stripline 308. In one example, this dimension of ceramic component 102 may enable stripline 308 to be effectively embedded within the ceramic material. In this example, the half wavelength ceramic block may effectively act, serve, and/or function as a short for the transmitted signal. In certain embodiments, RF device 300 may offer and/or provide a number of advantages (such as the avoidance of tight manufacturing tolerances, hole formations, and/or use of a tuning screw) over conventional approaches.

In some examples, RF device 300 may include and/or represent tuning element 112 that facilitates adjusting and/or modifying the frequency parameters of RF device 300 and/or a corresponding RF signal. In one example, tuning element 112 may be inserted into a hole located and/or positioned on the side opposite connector 104.

As explained above, the exemplary devices, components, and/or features illustrated in FIGS. 1-3 may include and/or represent a ceramic body. The ceramic body may extend further in the rightward direction (e.g., along the y-axis) although not explicitly illustrated in FIGS. 1-3. For example, exemplary ceramic component 102 may include and/or represent a waveguide of any suitable length. In some examples, the ceramic body may have a generally square and/or rectangular cross-section (in a plane normal to those illustrated in FIGS. 1-3). In such examples, connector 104 may include and/or represent a coaxial connector with a central electrical conductor and/or a surrounding dielectric material (e.g., ceramics, glasses, glass-ceramics, polymers, polymer composites, etc.)

In some examples, ceramic component 102 may include and/or represent a low-loss solid dielectric material (at a typical operating temperature) with a relative dielectric constant (at an operational frequency) of between 10 and 140. In one example, the electrical connection formed between ceramic component 102 and connector 104 may include or be facilitated by a socket or similar structure. For example, conductive pin 106 may be electrically connected to a coaxial socket or other terminal. In this example, one or more conductive elements of a connector (e.g., a cable, waveguide, etc.) may be received by the socket in order to electrically couple the connector to a resonator or another component through the electrical connection. Additionally or alternatively, conductive pin 106 may be electrically connected to a generally cylindrical element or another element configured to receive the connector.

In some examples, RF device 100, 200, or 300 may include and/or represent one or more ceramic elements (e.g., ceramic resonators) and an electrically conductive housing (such as a metal housing) that encloses the ceramic elements. The housing may include and/or represent one or more sockets for receiving and/or mating with any type of connector. An example socket may be electrically connected to a pin, a stripline, or any other suitable electrical connection, including any of those discussed above in connection with FIGS. 1-3.

In some examples, a transmission bandpass center frequency and/or bandwidth may be controlled and/or defined by resonator dimensions, aperture configurations (e.g., dimensions of a slot or other aperture formed in an electrically conductive layer), connection component dimensions (e.g., one or more dimensions of a pin, a stripline, a patch, or any other connection component), surface profiles (e.g., the profile of a stepped surface of a component or an electrically conductive structure), iris dimensions, and/or tuning elements or screws. Coupling structure configurations, such as electrical connections, may further include and/or represent capacitive and/or inductive irises, the size and/or configurations of which may be used to adjust transmission parameters (e.g., transmission bandwidth, etc.). In this context, a resonator may produce and/or provide one or more electromagnetic resonances in, for example, the RF spectrum.

In some examples, a patch may be formed on an end surface of a ceramic component. The patch may be located within a central portion of the end surface. The electrical connection between the connector and the patch may be provided and/or supported by a stripline or any other suitable connection. In one example, the patch may be embedded in a ceramic resonator and electrically connected to the exterior (e.g., to a socket, connector, or the like) through a conductive element (such as a pin, wire, stripline, or the like).

In some examples, RF device 100, 200, or 300 may include and/or represent a component (e.g., a waveguide, a resonator, and/or a filter), an input connector having an input connection to the component, and/or an output connector having an output connection to the component. In one example, the component may include and/or represent an input port coupling the input resonator to a multi-mode resonator, an output port coupling the multi-mode resonator to an output resonator, and/or an output connector coupled to the output resonator. The connector may include and/or represent a central conductor surrounded by an electrical insulator layer.

In some examples, such components may be used by and/or incorporated in one or more connections that include RF filters (such as single band filters, dual band filters, and/or multi-band filters). For example, a dual band filter may include and/or represent a ceramic waveguide dual bandpass filter configured as a compact multipole (e.g., a 4-pole or a 6-pole) filter for dual band operation. In one example, the dual band filter may receive an input signal from an input connector and/or provide an output signal to an output connector.

In some examples, RF device 100, 200, or 300 may include and/or represent an RF component configured and/or designed to facilitate, provide, and/or support one or more predetermined transmission pass bands. In one example, such transmission pass bands may represent and/or correspond to frequencies used in communications network protocols.

In some examples, such an RF component may include and/or represent a filter or waveguide with at least one dimension of approximately one quarter wavelength (λ/4). For example, a waveguide may have a generally rectangular cross-section. In this example, the width of the rectangular cross-section may be approximately a quarter wavelength.

The wavelength of electromagnetic radiation in an air-filled cavity may be effectively the same as the wavelength of electromagnetic radiation in a vacuum (sometimes referred to as the free space wavelength). In some examples, resonator dimensions may be designed according to and/or based on the wavelength or some multiple or fraction of the wavelength (e.g., λ/4). In such examples, at least one of those dimensions (e.g., the cross-sectional area or volume) may be reduced using a material having a relative permittivity greater than 1. The electromagnetic radiation wavelength (sometimes referred to as simply the wavelength) within a medium may be the free space wavelength divided by the refractive index of the medium.

At higher frequencies (e.g., above dielectric relaxation frequencies), the refractive index may be effectively the square root of the relative permittivity. In some examples, one or more dimensions of a resonator may be reduced by a factor of √(εᵣ), where εᵣ represents the relative dielectric constant of the filter material. In such examples, one or more resonators, waveguides, or other components may include and/or represent a material with a high dielectric constant and/or a low dielectric loss. For example, the dielectric constant may be greater than approximately 10 (e.g., in the range of 20-140, 20-100, and/or 25-50). Additionally or alternatively, the dielectric loss may be less than 0.001 at one or more operational frequencies (e.g., one or more bandpass center frequencies). In one example, the dielectric loss may be approximately equal to or less than 10⁻⁴ or even 10⁻⁵.

In some examples, a tuning hole may be formed in a ceramic component, and the tuning hole may be configured to receive a tuning element (e.g., a tuning screw, a tuning rod, or another mechanically adjustable electrically conductive element). The tuning element may be used to tune the resonance frequency of the electrical connection between the ceramic component and the connector. The depth of the tuning element within the tuning hole may be adjustable, for example, to modify and/or tune the transmission parameters of the ceramic component in combination with the electrical connection. The tuning hole may be located proximate to an end of the ceramic component and/or a hole that receives a conductive pin from the connector.

In some examples, RF device 100, 200, or 300 may be reversible such that a first operational mode enables signals to pass through the device in one direction and a second operational mode enables signals to pass through the device in the reverse direction. Accordingly, these operational modes may facilitate reversing and/or swapping the input and output. In one example, a multi-band filter (e.g., a dual band filter) may include and/or represent one or more multi-mode resonators.

In some examples, RF device 100, 200, or 300 may receive an input signal through a suitably configured input waveguide. The output signal may be transmitted through a suitably configured output waveguide. In one example, the input and/or output waveguide may be integrated with filter elements in the device. In this example, the input and/or output waveguide may include and/or represent a ceramic material.

In some examples, RF device 100, 200, or 300 may be incorporated and/or integrated into cellphone network devices (e.g., 4G devices, 5G devices, LTE devices, and/or ground stations) and/or multiple-input multiple-output (MIMO) data transmission devices (e.g., massive MIMO data transmission devices). In other examples, the dimensions of RF device 100, 200, or 300 may be appropriately scaled for other applications, such as millimeter wave devices, microwave devices, satellite communication devices, and the like.

In some examples, RF device 100, 200, or 300 may include and/or represent a resonator (and optionally associated coupling structures) fabricated from a monolithic block of ceramic. In one example, RF device 100, 200, or 300 may be assembled from separate resonators, coupling structures, waveguides, and the like. In this example, a resonator may be fabricated with and/or from one or more coupling structures (e.g., irises, slots, narrowed portions, apertures, and the like).

In some examples, RF device 100, 200, or 300 may include and/or represent a ceramic component and an input connection to the ceramic component. The input connection may include and/or represent an electrically conductive pin at least partially extending into a hole formed in the ceramic component. The pin may be electrically connected to the central conductor of an input connector, for example, by a direct connection through soldering or through a socket. The input connector may constitute and/or represent a coaxial fitting having a central conductor. In one example, a portion of the central conductor may represent and/or provide the pin.

In some examples, an input and/or output connection may facilitate and/or provide RF coupling of an RF signal into and/or out of the ceramic component. In other examples, the input and/or output connection may facilitate and/or provide electromagnetic coupling of an RF signal in a connector to the ceramic component and/or vice versa.

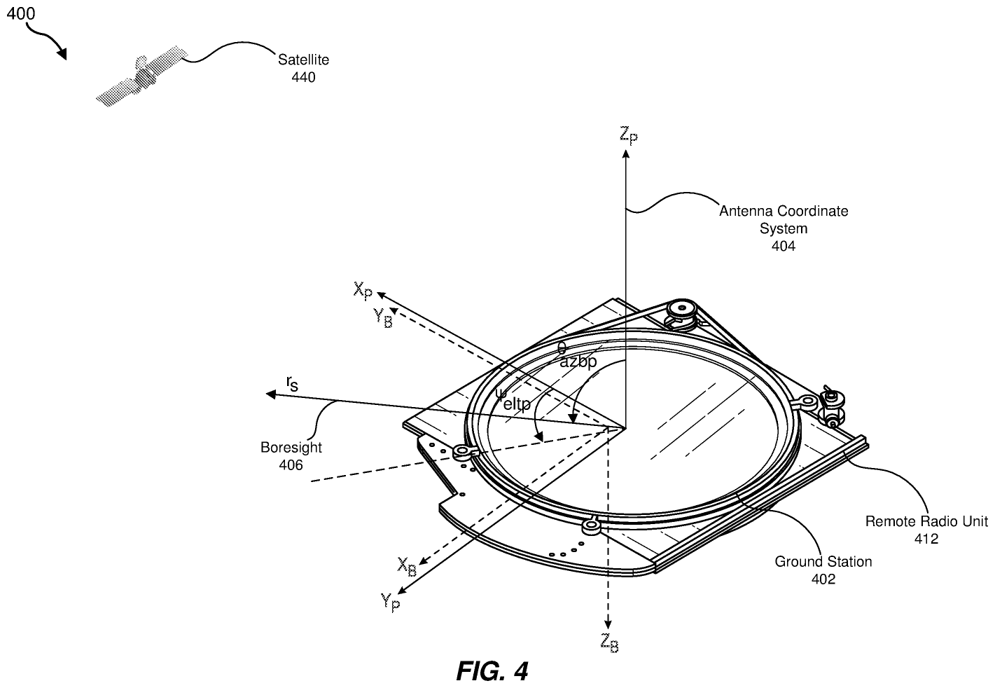

FIG. 4 illustrates an exemplary system 400 in which a ground station 402 tracks a satellite 440 passing overhead. As illustrated in FIG. 4, ground station 402 may steer, direct, and/or aim a boresight 406 of an antenna in a certain direction in an effort to track and/or follow satellite 440. In some examples, ground station 402 may include and/or represent a remote radio unit 412. In such examples, remote radio unit 412 may include and/or represent one or more instances of RF device 100, 200, or 300 as described above. In one example, each instance of RF device 100, 200, or 300 may include and/or represent a RF circuit communicatively coupled directly or indirectly to the antenna. Accordingly, one or more RF components may be coupled between RF circuit and the antenna.

In some examples, ground station 402 may steer, direct, and/or aim boresight 406 in accordance with an antenna coordinate system 404. In one example, antenna coordinate system 404 may implement and/or operate an overall pointing formula of (θ_{el_m}, ψ_{az_m})=f(θₑₗₜₚ,ψ_{azbp}), which facilitates mapping angles of boresight 406 to the displacement angles of the azimuth and elevation motors. This pointing formula may lead to an azimuth formula of θ=a sin (2 sin

$$( \frac{{θ}_{r}}{2} ) )$$

and/or an elevation formula of

$$ϕ = ( \frac{{θ}_{r}}{2} + sign ( {θ}_{r} ) \times 90 ) .$$

In one example, antenna coordinate system 404 may include and/or represent a body coordinate frame denoted in FIG. 4 with the subscript “B” and a pointing coordinate frame denoted in FIG. 4 with the subscript “P”. In this example, the body coordinate frame may be right-handed with the z-axis pointing downward, and the pointing coordinate frame may be right-handed with the z-axis pointing upward. Additionally or alternatively, boresight 406 may be defined and/or aimed by (1) an elevation angle positioned between the beam-pointing vector and the xₚyₚ plane and (2) an azimuth angle measured from the xₚ axis.

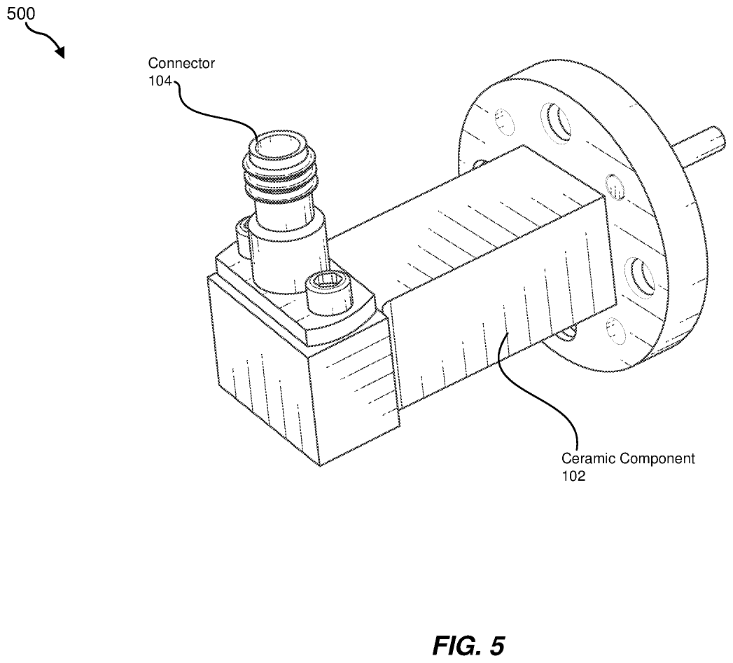

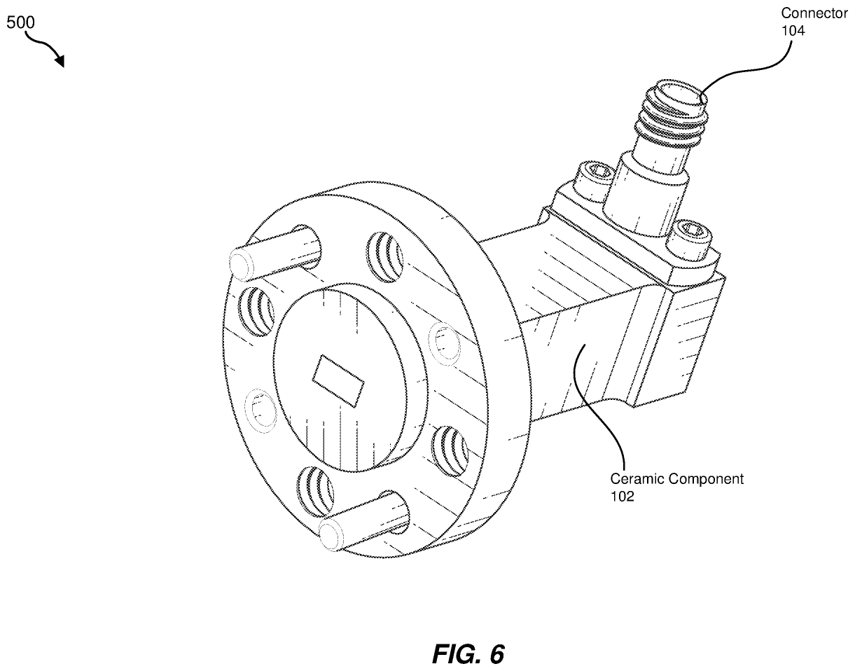

FIGS. 5 and 6 illustrates different perspective views of an RF device 500 that includes and/or represents ceramic component 102 and connector 104. As illustrated in FIGS. 5 and 6, connector 104 may include and/or represent a coaxial fitting and/or connector. In some examples, ceramic component 102 may include and/or represent a waveguide physically, electrically, and/or communicatively coupled to connector 104. In one example, RF device 500 may be implemented and/or incorporated in a remote radio unit of a ground station. By implementing and/or incorporating RF device 500 in this way, the ground station may achieve and/or embody an improved design by reducing the ground station's size, weight, bulk, and/or cost using solid dielectric and/or ceramic components rather than air-filled metal cavities.

FIG. 7 is a flow diagram of an exemplary method 700 for achieving improved ground station design. In one example, the steps shown in FIG. 7 may be performed during and/or as part of the manufacture and/or assembly of a ground station. Additionally or alternatively, the steps shown in FIG. 7 may also incorporate and/or involve various sub-steps and/or variations consistent with the descriptions provided above in connection with FIGS. 1-6.

As illustrated in FIG. 7, method 700 may include and/or involve the step of creating a ceramic component for incorporation in a remote radio unit of a ground station (710). Step 710 may be performed in a variety of ways, including any of those described above in connection with FIGS. 1-6. For example, a communications equipment vendor or subcontractor may create a ceramic component for incorporation in a remote radio unit of a ground station.

Method 700 may also include the step of forming a hole in the ceramic component to accommodate an electrically conductive pin of a connector (720). Step 720 may be performed in a variety of ways, including any of those described above in connection with FIGS. 1-6. For example, the communications equipment vendor or subcontractor may form a hole in the ceramic component to accommodate an electrically conductive pin of a connector.

Method 700 may further include the step of coupling the connector to the ceramic component such that the electrically conductive pin at least partially extends into the hole formed in the ceramic component (730). Step 730 may be performed in a variety of ways, including any of those described above in connection with FIGS. 1-6. For example, the communications equipment vendor or subcontractor may couple the connector to the ceramic component such that the electrically conductive pin at least partially extends into the hole formed in the ceramic component.

### Example Embodiments

Example 1: A radio-frequency device comprising (1) a ceramic component that forms a hole and (2) a connector coupled to the ceramic component, wherein the connector comprises an electrically conductive pin that at least partially extends into the hole formed in the ceramic component.

Example 2: The radio-frequency device of Example 1, wherein the connector comprises a coaxial connector having a central conductor, the electrically conductive pin being electrically connected to or physically extending from the central conductor of the coaxial connector.

Example 3: The radio-frequency device of Example 1 or 2, wherein (1) the ceramic component comprises a solid ceramic body and (2) the hole is formed in the solid ceramic body.

Example 4: The radio-frequency device of any of Examples 1-3, wherein the solid ceramic body is formed into a rectangular prism or cuboid shape.

Example 5: The radio-frequency device of any of Examples 1-4, wherein the ceramic component comprises at least one a waveguide, a resonator, or a bandpass filter.

Example 6: The radio-frequency device of any of Examples 1-5, wherein the connector comprises an input connector having a central conductor, the electrically conductive pin being electrically connected to or physically extending from the central conductor of the input connector.

Example 7: The radio-frequency device of any of Examples 1-6, wherein the connector comprises an output connector having a central conductor, the electrically conductive pin being electrically connected to or physically extending from the central conductor of the output connector.

Example 8: The radio-frequency device of any of Examples 1-7, wherein the output connector comprises a coaxial fitting.

Example 9: The radio-frequency device of any of Examples 1-8, wherein the hole is formed at a certain distance from an end surface of the ceramic component, wherein the certain distance is equal to approximately one quarter wavelength of a transmission bandwidth of the radio-frequency device.

Example 10: The radio-frequency device of any of Examples 1-9, wherein the ceramic component includes a stepped profile on an outer surface.

Example 11: The radio-frequency device of any of Examples 1-10, further comprising a conductive structure incorporated in the ceramic component, wherein the electrically conductive pin of the connector extends through a surface of the ceramic component and is connected to the conductive structure.

Example 12: The radio-frequency device of any of Examples 1-11, wherein the conductive structure incorporated in the ceramic component includes at least one stepped profile on a surface covered by the ceramic component.

Example 13: The radio-frequency device of any of Examples 1-12, further comprising an adjustable tuning element positioned substantially opposite the connector relative to the ceramic component.

Example 14: The radio-frequency device of any of Examples 1-13, wherein the electrically conductive pin comprises a patch and a stripline electrically coupled between the patch and the connector.

Example 15: A remote radio unit of a ground station comprising (1) a radio-frequency circuit comprising (A) a ceramic component that forms a hole and (B) a connector coupled to the ceramic component, wherein the connector comprises an electrically conductive pin that at least partially extends into the hole formed in the ceramic component, and (2) an antenna communicatively coupled to the radio-frequency circuit.

Example 16: The remote radio unit of Example 15, wherein the connector comprises a coaxial connector having a central conductor, the electrically conductive pin being electrically connected to or physically extending from the central conductor of the coaxial connector.

Example 17: The remote radio unit of either Example 15 or Example 16, wherein (1) the ceramic component comprises a solid ceramic body and (2) the hole is formed in the solid ceramic body.

Example 18: The remote radio unit of any of Examples 15-17, wherein the solid ceramic body is formed into a rectangular prism or cuboid shape.

Example 19: The remote radio unit of any of Examples 15-18, wherein the ceramic component comprises at least one of a waveguide, a resonator, or a bandpass filter.

Example 20: A method comprising (1) creating a ceramic component for incorporation in a remote radio unit of a ground station, (2) forming a hole in the ceramic component to accommodate an electrically conductive pin of a connector, and (3) coupling the connector to the ceramic component such that the electrically conductive pin at least partially extends into the hole formed in the ceramic component.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A radio-frequency device comprising:
a ceramic component that forms a hole; and
a connector coupled to the ceramic component, wherein the connector comprises an electrically conductive pin that at least partially extends into the hole formed in the ceramic component.

2. The radio-frequency device of claim 1, wherein the connector comprises a coaxial connector having a central conductor, the electrically conductive pin being electrically connected to or physically extending from the central conductor of the coaxial connector.

3. The radio-frequency device of claim 1, wherein:
the ceramic component comprises a solid ceramic body; and
the hole is formed in the solid ceramic body.

4. The radio-frequency device of claim 3, wherein the solid ceramic body is formed into a rectangular prism or cuboid shape.

5. The radio-frequency device of claim 1, wherein the ceramic component comprises at least one of:
a waveguide;
a resonator; or
a bandpass filter.

6. The radio-frequency device of claim 1, wherein the connector comprises an input connector having a central conductor, the electrically conductive pin being electrically connected to or physically extending from the central conductor of the input connector.

7. The radio-frequency device of claim 1, wherein the connector comprises an output connector having a central conductor, the electrically conductive pin being electrically connected to or physically extending from the central conductor of the output connector.

8. The radio-frequency device of claim 7, wherein the output connector comprises a coaxial fitting.

9. The radio-frequency device of claim 1, wherein the hole is formed at a certain distance from an end surface of the ceramic component, wherein the certain distance is equal to approximately one quarter wavelength of a transmission bandwidth of the radio-frequency device.

10. The radio-frequency device of claim 1, wherein the ceramic component includes a stepped profile on an outer surface.

11. The radio-frequency device of claim 1, further comprising a conductive structure incorporated in the ceramic component, wherein the electrically conductive pin of the connector extends through a surface of the ceramic component and is connected to the conductive structure.

12. The radio-frequency device of claim 11, wherein the conductive structure incorporated in the ceramic component includes at least one stepped profile on a surface covered by the ceramic component.

13. The radio-frequency device of claim 1, further comprising an adjustable tuning element positioned substantially opposite the connector relative to the ceramic component.

14. The radio-frequency device of claim 1, wherein the electrically conductive pin comprises:
a patch; and
a stripline electrically coupled between the patch and the connector.

15. A remote radio unit of a ground station comprising:
a radio-frequency circuit comprising:
a ceramic component that forms a hole; and
a connector coupled to the ceramic component, wherein the connector comprises an electrically conductive pin that at least partially extends into the hole formed in the ceramic component; and
an antenna communicatively coupled to the radio-frequency circuit.

16. The remote radio unit of claim 15, wherein the connector comprises a coaxial connector having a central conductor, the electrically conductive pin being electrically connected to or physically extending from the central conductor of the coaxial connector.

17. The remote radio unit of claim 15, wherein:
the ceramic component comprises a solid ceramic body; and
the hole is formed in the solid ceramic body.

18. The remote radio unit of claim 17, wherein the solid ceramic body is formed into a rectangular prism or cuboid shape.

19. The remote radio unit of claim 15, wherein the ceramic component comprises at least one of:
a waveguide;
a resonator; or
a bandpass filter.

20. A method comprising:
creating a ceramic component for incorporation in a remote radio unit of a ground station;
forming a hole in the ceramic component to accommodate an electrically conductive pin of a connector; and
coupling the connector to the ceramic component such that the electrically conductive pin at least partially extends into the hole formed in the ceramic component.
